(19) United States
(12) Patent Application Publication
(10) Pub. No.: US 2007/0139877 A1
(43) Pub. Date: Jun. 21, 2007

(54) Slide mechanism for a portable device and a portable device comprising the same

(76) Inventor: Hideo Kato, Yokohama (JP)

Correspondence Address: NOTARO AND MICHALOS, 100 DUTCH HILL ROAD, SUITE 110, ORANGEBURG, NY, 10962-2100, US

(21) Appl. No.: 11/638,123

(22) Filed: Dec. 13, 2006

(30) Foreign Application Priority Data
Dec. 21, 2005 (JP) 2005-367381

(51) Int. Cl. G06F 1/16

(52) U.S. Cl. 361/683; 439/159

(57) ABSTRACT

A slide mechanism of a portable device and a portable telephone comprising such a slide mechanism is provided for a semi-automatic opening and closing with a simpler structure, as well as for an opening and closing with an improved operability. The slide mechanism slides a first casing and a second casing relative to each other with the first and second casings superposed on each other in a longitudinal direction, thus realizing a closed state where an upper surface of one of the casings is covered with a lower surface of the other casing, as well as an opened state where the upper surface of one of the casings is exposed. In this slide mechanism, a compression spring is swingably provided between both casings, with one end being operatively attached to the first casing and the other end to the second casing, thus slidably biasing both casings relative to each other from a predetermined opening or closing position either in an opening direction or a closing direction.

### BACKGROUND OF THE INVENTION

1. Field of the Invention

The present invention relates to a slide mechanism of a portable device adapted for sliding a first casing and a second casing of the portable device relative to one another in a linear direction with the first and second casings being superposed on each other. The present invention also relates to a portable device, such as a portable telephone, comprising such a slide mechanism.

2. Description of the Related Art

Portable telephones, which are a kind of portable device that utilize a slide mechanism, are available in the market. Typically, such portable telephones contain a transmitter section in a first casing, and a receiver section in a second casing. The transmitter section is typically provided with a keyboard section, a microphone section and the like on its upper surface. The receiver section is typically provided with a display section, a speaker section and the like on its upper surface. This type of portable telephone thus realizes a closed state on one hand, in which the first casing and the second casing are entirely superposed on each other, allowing the upper surface of the first casing to be covered by the second casing, and a opened state on the other, in which the second casing is slid in a linear or longitudinal direction relative to the first casing, allowing the upper surface of the first casing to be exposed. An example of a portable telephone having such a slide mechanism is disclosed in Japanese Patent Application Laid-open No. 2003-125052.

In the slide mechanism according to this laid-open patent application, a slide case made up of a slide cover and a locking plate being superposed on and fixed to each other is mounted on the lower surface of a second casing, while a slider slidably contained in the slide case is mounted on the upper surface of a first casing. Thus, the second casing can be slid relative to the first casing. According to such structure, all relative operations of the first casing and the second casing, that is, the slide operations need to be performed manually, which suffers drawbacks in terms of its operability. Therefore, the Applicant has proposed a slide mechanism of a portable device constructed to allow a semi-automatic slide operation.

This slide mechanism comprises, e.g., a base member mounted on either one of the first casing and the second casing, a slider slidably engaged with the base member, and a torsion spring provided between the base member and the slider for slidably biasing the slider from a slide position in a closing direction or an opening direction. Since, in this mechanism, the slider is slid with regard to the base member from the predetermined slide position into the closing or the opening direction, the second casing can be automatically opened and closed from a predetermined slide position with regard to the first casing. Thus, the second casing can be automatically opened and closed at a predetermined slide position. It is more challenging to achieve a good slide biasing using a torsion spring depending from its location, requiring therefore a more complex structure. Furthermore, in opening and closing semi-automatically in both of the opening and closing directions, a manual slide operation is necessary up to a predetermined slide position. In addition, this manual slide operation is forcibly conducted against a biasing force of a biasing means. Accordingly, further improvements are needed to overcome these disadvantages.

### SUMMARY OF THE INVENTION

The present invention aims to solve the above-described problems. Its first object is to provide a slide mechanism of a portable device, which has a simple structure and enables a semi-automatic opening and closing of the portable device. The present invention also provides a portable telephone comprising the slide mechanism of the present invention. Its second object is to provide a slide mechanism, which achieves opening/closing operations with an improved operability, and a portable telephone having the same improvements.

To achieve the above-mentioned first object, a slide mechanism of the portable device according to the present invention provides a structure for sliding a first casing and a second casing relative to one another in a longitudinal direction with the first and second casings being superposed on each other. In this manner, the sliding mechanism realizes a closed state on one hand, in which the first and second casings are entirely superposed on each other, allowing the upper surface of the first casing to be covered by the second casing, and an opened state on the other hand, in which the first and second casings slide relative to each other in a longitudinal direction, allowing the upper surface of the first casing to be exposed. The slide mechanism of the first exemplary embodiment includes a compression spring, which is swingably mounted thereon with one end portion thereof being attached to the first casing and other end portion to the second casing for slidably biasing the first and second casings from a predetermined opening/closing position either into an opening or closing direction.

According to this invention, semi-automatic opening and closing operations can be achieved, since the second casing is slidably biased toward the opening or closing direction with regard to the first casing from the predetermined opening/closing position. Thus, with a use of a compression spring as a slide biasing means, a semi-automatic opening and closing operation is realized through a simpler structure.

To achieve the above-mentioned second object, a slide mechanism of the portable device according to the present invention provides a structure for sliding a first casing and a second casing relative to each other in a longitudinal direction with the first and second casings superposed on each other. In this manner, the sliding mechanism realizes a closed state on one hand, in which the first and second casings are entirely superposed on each other, allowing the upper surface of the first casing to be covered by the second casing, and a opened state on the other hand, in which the upper surface of the first casing is exposed. The slide mechanism of the second exemplary embodiment comprises: (1) a semi-automatic mechanism having a slide biasing means which is attached between the first casing and the second casing, with one end portion thereof being attached to a first attaching portion of the first casing and other end portion to a second attaching portion of the second casing, for slidably biasing the first and second casings from a predetermined opening/closing position either into an opening or closing direction; and (2) a fully automatic mechanism having either one of the first attaching portion and the second attaching portion rotatably attached to either one of the first casing and the second casing, and a driving means which slidably biases the first and second casings automatically either from the closed state towards the opened state or from the opened state towards the closed state, via a biasing force of either one of the first and second attaching portions and of the slide biasing means while this one attaching portion is rotated. Therefore, a manual opening/closing operation can be achieved using the semi-automatic mechanism, along with an automatic opening/closing operation using the fully automatic mechanism.

According to this invention, in case that the first and second casings are manually slid with regard to each other, the second casing, e.g., is slidably biased from a predetermined opening/closing position with regard to, e.g., the first casing into an opening or closing direction via the slide biasing means of the semi-automatic mechanism. Therefore, a semi-automatic opening and closing operation is achieved. Furthermore, through a rotation of either one of the attaching portions via a driving means of a fully automatic mechanism, the first and second casings are slidably biased automatically due to a biasing force of the slide biasing means of semi-automatic mechanism, and are opened or closed either from a closed state to an opened state or from the opened state to the closed state. Thus, with a use of the slide biasing means an opening and closing is achieved both manually and automatically, one by the semi-automatic mechanism, and the other by the automatic mechanism. Therefore, the present invention has excellent operability and enables an opening and closing operation using a simpler structure.

In the slide mechanism of the portable device according to the present invention, it is preferable that the above-described slide biasing means is a compression spring. Additionally, in the slide mechanism of the portable device according to the present invention, it is desirable that the second casing is slidably engaged with the first casing via a base member to be attached to one of the first casing and second casing, and via a slider slidably engaged with the base member and attached to the other one of the first casing and second casing. Moreover, in the slide mechanism of the portable device according to the present invention, the above-mentioned driving means preferably includes a gear member attached to the above-mentioned one of the attaching portions; and a driving motor having a rotation axis adapted to mesh with the gear member and be rotatable in clockwise and counterclockwise directions. In addition, in the slide mechanism of the portable device according to the present invention, it is preferable that the above-mentioned driving motor has a rotation axis which can be rotated with no load, when the first and second casings are manually opened and closed relative to each other.

Furthermore, a portable telephone according to the present invention is characterized in that it is provided with the above-described slide mechanism. According to one embodiment of the present invention, similar to the foregoing, a compression spring may be used as a slide biasing means for slidably biasing a first casing and a second casing manually relative to each other to permit a semi-automatic opening/closing operation with a simpler structure. In addition, a semi-automatic mechanism and a fully automatic mechanism using the slide biasing means of semi-automatic mechanism for slidably biasing the first and second casings automatically with regard to each other are both provided to achieve two types of opening/closing operation—one manually by a semi-automatic mechanism and the other automatically by a fully automatic mechanism—with both mechanisms using a slide biasing means of the semi-automatic mechanism. Therefore, the present invention improves operability and enables an opening/closing operation utilizing a simpler structure.

As described thus far, according to the slide mechanism of the portable device (e.g., portable telephone) of the present invention, a semi-automatic opening/closing operation with a simpler structure is achieved, since a compression spring is used as a slide biasing means for slidably biasing a first casing and a second casing manually with regard to each other. In addition, both the semi-automatic mechanism and the fully automatic mechanism utilize the slide biasing means of the semi-automatic mechanism for slidably biasing the first and second casings automatically relative to each other, which permits two types of opening/closing operation—one manually by the semi-automatic mechanism and the other automatically by the fully automatic mechanism—with both mechanism using the slide biasing means of the semi-automatic mechanism. Therefore, the present invention improves operability and enables opening/closing operations with a simpler structure.

### BRIEF DESCRIPTION OF THE DRAWINGS

FIG. 1A and FIG 1B are plan views of a slide mechanism of a portable device according to the present invention. FIG. 1A shows a closed state of the portable device. FIG 1B shows a neutral state of the portable device, for example, during the transition of the first and second casings manually from a closed to an opened state or automatically from an opened to a closed state;

FIG. 2A and FIG. 2B are plan views a slide mechanism of a portable device according to the present invention. FIG. 2A shows a neutral state of the portable device, for example, during the transition of the first and second casings manually from an opened to a closed state or automatically from a closed to an opened state and FIG. 2B shows an opened state of a portable device;

FIG. 3 shows a schematic sectional view a slide mechanism of a portable device according to the present invention;

FIG. 4 shows an exploded perspective view of a slide mechanism of a portable device according to the present invention; and

FIG. 5A to FIG. 5C are plan views of a portable telephone according to the present invention. FIG. 5A shows a closed state of the portable telephone, FIG. 5B shows a neutral state of the same, and FIG. 5C shows an opened state of the same.

### DETAILED DESCRIPTION OF THE PREFERRED EMBODIMENTS

Hereinafter, a slide mechanism of a portable device according to the present invention will be described in reference to the attached drawings.

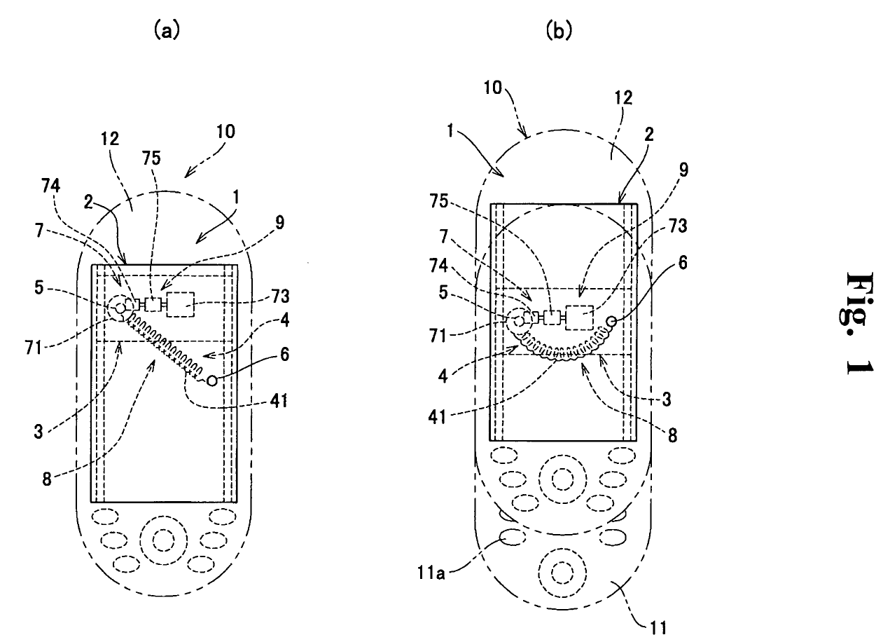

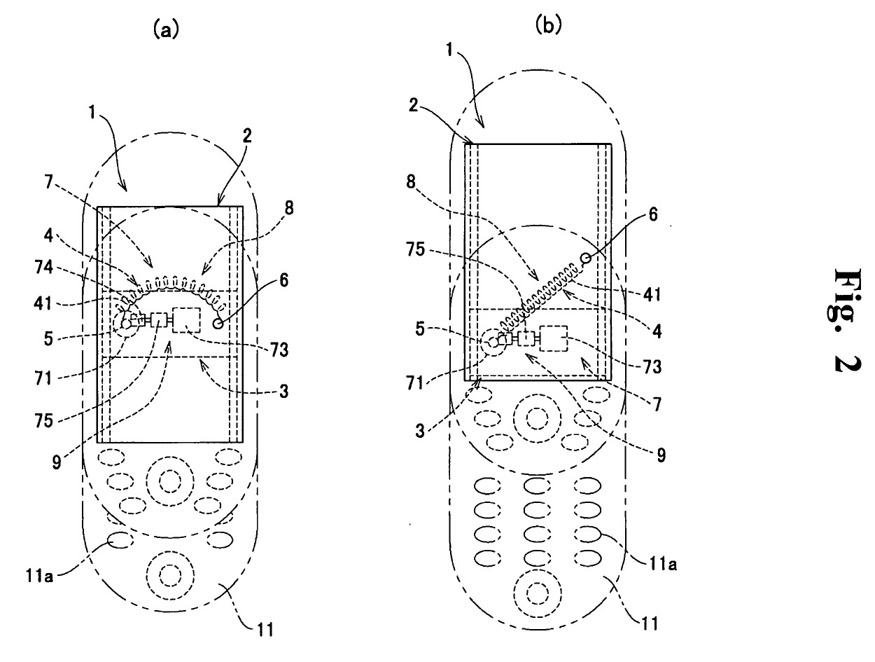

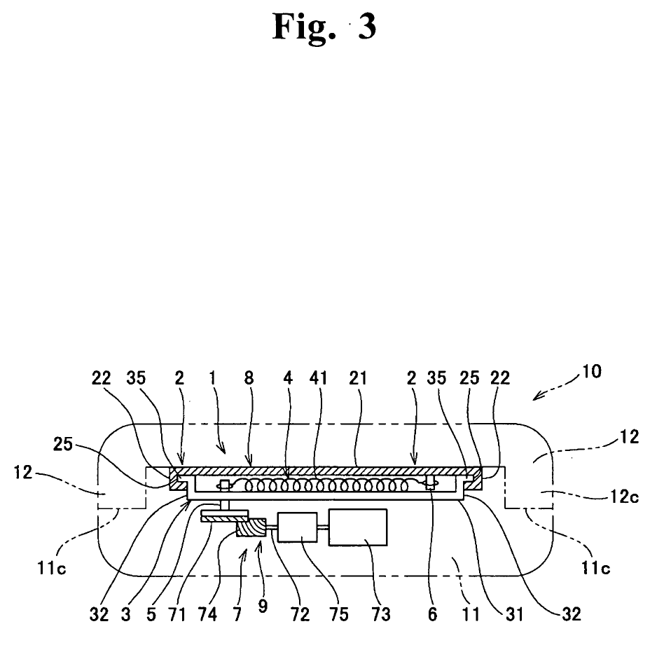

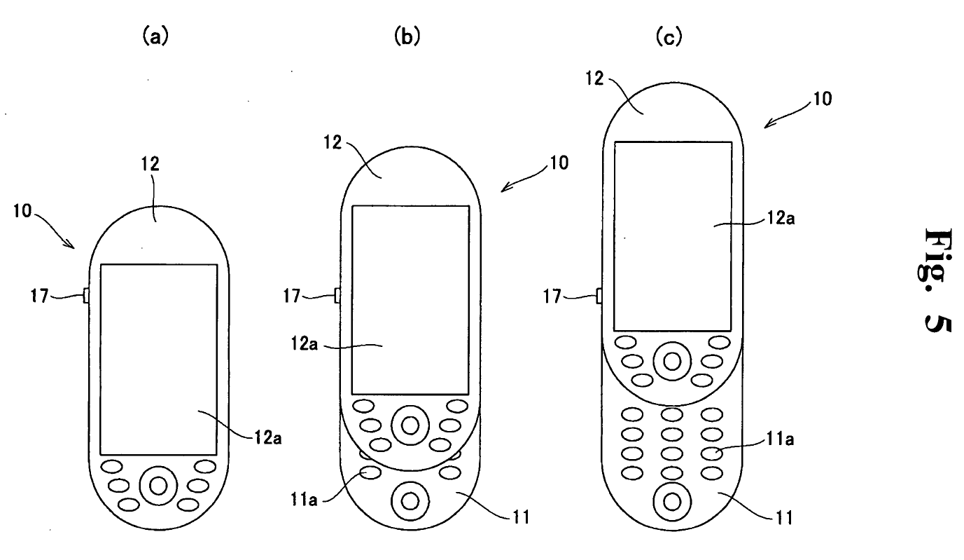

FIG. 1 to FIG. 5 shows a slide mechanism of a portable device according to the present invention. As shown in FIGS. 1 to 5, the slide mechanism comprises a first casing 11 and a second casing 12 which are superposed on each other and are slidable relative to each other in a longitudinal direction, between a closed state and an opened state. In the closed state, an upper surface of one of the first casing 11 and the second casing 12 is covered with a lower surface of the other one of the first casing 11 and the second casing 12 (see FIGS. 1A and 5A). In the opened state, at least a portion of the upper surface of the first casing 11 is exposed (see FIGS. 2B and 5C). A state between the opened and closed states is a neutral state (see FIGS. 1B, 2A, and 5B).

A slide mechanism 1 of the portable device according to the present invention is characterized in that it includes a semi-automatic mechanism 8 having a slide biasing means 4. The slide biasing means 4 is mounted between a first casing 11 and a second casing 12, with an end portion thereof being attached to a first attaching portion 5 of the first casing 11 and other end portion being attached to a second attaching portion 6 of the second casing 12. In this manner, the slide biasing means 4 slidably biases the first casing 11 and the second casing 12 relative to each other at a predetermined opening/closing position (it may be called neutral position) in an opening and closing direction. The slide mechanism 1 is further characterized in that a fully automatic mechanism 9 having a driving means 7 for slidably biasing the first casing 11 and the second casing 12 automatically, either from a closed to an opened state or from an opened to a closed state, (1) via the first attaching portion 5 or the second attaching portion 6, herein with the first attaching portion 5 rotatably attached to either one of the first casing 11 and second casing 12; and (2) utilizing the biasing force of a slide biasing means 4 generated by a rotation of the first attaching portion 5. The slide mechanism is further characterized in that two types of opening/closing operation, one manually via a semi-automatic mechanism 8, and the other automatically via a fully automatic mechanism 9, are achieved with the use of a slide biasing means 4 of the semi-automatic mechanism 8.

The slide mechanism of the present invention may be incorporated into a wide range of portable products, including but not particularly limited to, portable telephones, portable information terminals, such as Zaurus™ handheld PDA, calculators, pocket computers, portable gaming machines and the like. The slide mechanism of the present invention is especially suitable for use in a portable telephone. Incidentally, the portable products may also include ashtrays, case lids and the like. The type of devices or products that can use the slide mechanism of the present invention is not particularly limited as long as there are two casings, which are configured to be slidable relative to each other. Although the invention is described with reference to specific embodiments, such as a portable telephone 10, it should be understood that the description is exemplary only, and changes and modifications thereto are possible without departing from the scope and spirit of the invention defined in the attached claims.

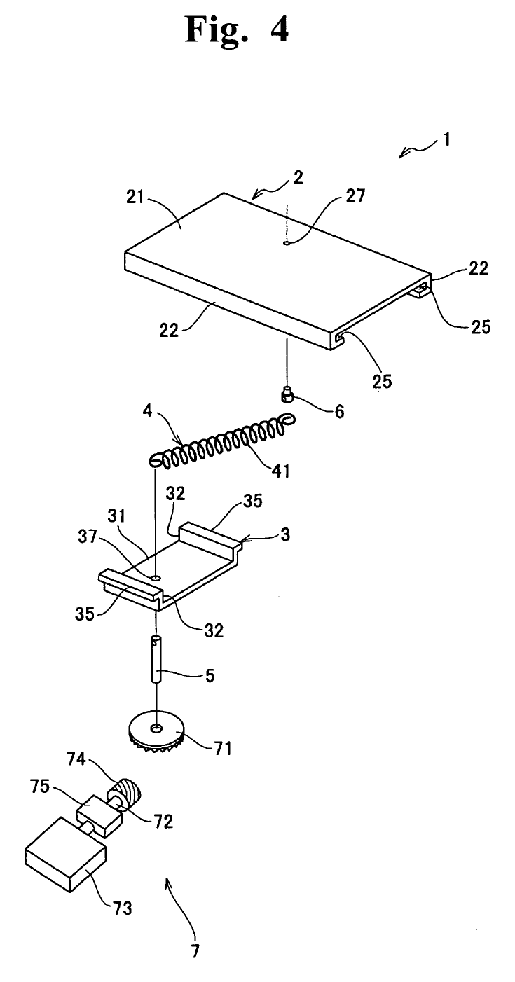

A first casing 11 as a transmitter section of a portable telephone 10 may include on its upper surface a keyboard portion 11a and a microphone portion (not shown). Preferably, the first casing 11 is formed in an elongate and substantially rectangular shape. A second casing 12, which constitutes a receiver section of the portable telephone 10, may include on its upper surface a display portion 12a such as a LCD screen (see FIG. 4), a speaker portion (not shown) and a camera portion (not shown). Preferably, the second casing 12 is formed substantially in the same shape as the first casing 11. The first casing 11 and second casing 12 are both illustrated in FIGS. 1 and 2 with phantom lines.

A portable telephone 10 is constructed through a connection of a first casing 11 and a second casing 12. In such a connection, e.g., the second casing 12 is slidable in a longitudinal linear direction with regard to the first casing 11 from a closed state, in which the second casing 12 is superposed on the first casing 11. In other words, in the portable telephone 10, a keyboard portion 11a, for example, is concealed when a lower surface of the second casing 12 is superposed on an upper surface of the first casing 11, and such keyboard portion 11a can be exposed through a sliding movement of the second casing 12 on the upper surface of the first casing 11.

In one embodiment, shelf portions 11c, 11c are formed on both sides on an upper surface of a first casing 11. On both sides of a lower surface of the second casing 12 are corresponding slide portions 12c, 12c which are adapted to slidably mate with the shelf portions 11c, 11c. The shelf portions 11c, 11c and the slide portions 12c, 12c are preferably constructed in such a manner that one end portions of the shelf portions 11c, 11c abut on one end portions of the slide portions 12c, 12c in a closed state, while other end portions of the shelf portions 11c, 11c abut on the other end portions of the slide portions 12c, 12c in an opened state. In another embodiment, the slide mechanism of the present invention may be of a structure without the shelf portions 11c, 11c and the slide portions 12c, 12c.

A second casing 12 can be slidably connected with a first casing 11 via engagement portions respectively provided on the first casing 11 and the second casing 12, as well as via a base member 2 and a slider 3, as shown in the drawings.

A base member 2 is secured to a lower surface of one of a first casing 11 and a second casing 12. Preferably, the base member 2 is secured to the casing with screws, adhesives or any other suitable fastening means conventionally used. The base member 2 is preferably formed in an elongate and substantially rectangular shape so as to be attached to a portion extending from a point near an upper end of the lower surface of the second casing 12 to a point near a lower end of the same. The base member 2 includes a base portion 21, preferably in an elongated and substantially rectangular shape; and side portions 22 with both side portions of the base portion 21 folded downwards (that is toward the first casing 11 substantially in a perpendicular direction). Preferably, the base member 2 has a U-shaped cross section. The base member 2 is constructed or molded of a suitable material, including, but not is limited to, pressed stainless metal plate and synthetic resin. In one embodiment, the base portion 21 of the base member 2 is slightly smaller in width than the second casing 12.

Each of the edges of the side portions 22 of the base member 2 is folded toward an inner surface (one of the surfaces opposed to each other) on the opposite side, substantially in a perpendicular direction to form a slide concave portion 25 or a C-shaped channel, which extends along each side of the base portion 21. On each of the side portions 22, the slide portion may extend continuously through the length of the slide concave portion 25 in a longitudinal direction, or the slide concave portions 25 may be made up of a plurality of segments formed at predetermined intervals. Furthermore, a first attaching hole 27 is provided about a central portion in a longitudinal direction and near one of the side portions 22 of the base portion 21. A second attaching portion 6 is attached to the first attaching hole 27 for allowing a slide biasing means 4 to be attached to the second attaching portion 6.

A slider 3 is secured to an upper surface of the other one of the first casing 11 and the second casing 12, preferably with screws, adhesive or any other suitable fastening means. The slider 3 is preferably formed in a substantially rectangular shape with longer side in, e.g., a lateral direction of the first casing 11. The slider 3 includes (1) a base portion 31, which is formed in a substantially rectangular shape; and (2) two side portions 32 of the base portion 31 protruding toward the second casing 12 substantially in a perpendicular direction. In other words, the slider 3 is constructed to have a substantially U shaped cross section. The slider 3 is formed of a suitable material, including, but not limited to, pressed stainless metal plate and synthetic resin.

A length between the outer surfaces (both surfaces on the back side of the surfaces opposed to each other) of both side portions 32 is preferably of a dimension slightly smaller than a distance between the edges folded inward of side portions 22. The edge(s) of each of the side portions 32 is/are folded substantially perpendicular in the opposite direction of each of the surfaces opposed to each other so as to make up slide convex portion(s) 35 to be slidably engaged with slide concave portion(s) 25. The slide convex portion(s) 35 is/are slidably engaged with corresponding slide concave portion(s) 25 of the base member 2, allowing for a relative linear sliding of a first casing 11 and a second casing in a longitudinal direction. The side portions 32 of the slider 3 are slidably engaged with the side portions 22 of the base member 2, and form a substantially elongate and rectangular hollow space between the base member 2 and the slider 3.

A slide control member (not shown) may be provided on slide concave portions 25 so that a first casing 11 and a second casing 12 can slide relative to each other only between a closed and an opened state. Alternatively, a slide control member (not shown) may be provided on the first casing 11 and the second casing 12 so that the casings can slide relative to each other only between the closed and the opened states. While the drawings illustrate a base member 2 attached to the second casing 12 and a slider 3 to the first casing 11, the arrangement can be employed in reverse with the base member 2 attached to the first casing and the slider 3 to the second casing.

Furthermore, a second attaching hole 37 is provided close to a central portion in a longitudinal direction and near one of the side portions 32 of the base portion 31, opposite the side portion closest to the first attaching hole 27. A rotation shaft 5 is attached to the second attaching hole 37 for attaching the other end portion of a slide biasing means 4 to the rotation shaft 5.

A slide biasing means 4 is one of the primary components of the semi-automatic mechanism 8, and slidably biases a slider 3 with regard to a base member 2 semi-automatically from a predetermined opening/closing position, e.g., from a neutral position (a neutral state) in an opening or closing direction. The slide biasing means 4 is mounted between the base member 2 and the slider 3. The slide biasing means 4 is not particularly limited, but, e.g., a compression spring 41 may be used.

One end portion of the compression spring 41 is attached to a second attaching portion 6, while other end portion of the compression spring is attached to a rotation shaft 5, without rotating around an axis thereof. A way of attaching the other end portion of the compression spring 41 to the rotation shaft 5 is not particularly limited, and may be achieved, for example, by providing a through hole (not shown) at the tip of the rotation shaft 5 and securing the other end portion of the compression spring 41 to the through hole. Thus, the compression spring 41 is swingably mounted between a base member 2 and a slider 3. Therefore, in the case of a manual sliding of the first casing 11, the second casing 12 can slide semi-automatically from a predetermined opening/closing position with regard to the first casing 11 in an opening or closing direction.

A fully automatic mechanism 9 preferably includes, e.g., a rotation shaft 5 and a driving means 7. The rotation shaft 5 as a first attaching portion is rotatably fitted into a second attaching hole 37 of a slider 3. Thus, the rotation shaft 5 passes through the second attaching hole 37 and to an end portion thereof protruding from the slider 3 the other end portion of a compression spring 41 is attached. To the other end portion of the rotation shaft 5, a gear member 71 of a driving means 7 is attached.

A driving means 7 transmits a torque to a rotation shaft 5 and thereby causes a compression spring 41 to bend, thus allowing a first casing 11 and a second casing 12 to be slidably biased automatically either from a closed to an opened state, or from an opened to a closed state. The driving means 7 enables the rotation shaft 5 to be rotated, but preferably comprises a gear member 71 attached to other end portion of the rotation shaft 5 and a driving motor 73 for imparting rotation in clockwise and counterclockwise directions to a motor-side rotation shaft 72 meshed with the gear member 71.

A gear member 71 is not particularly limited, but includes a bevel gear. A driving motor 73 is not particularly limited, provided that it allows a motor-side rotation shaft 72 to be rotated both in clockwise and counterclockwise directions. Preferably, a meshing member 74 such as a bevel gear is mounted at an end portion of the motor-side rotation shaft 72, and is configured to rotatably mesh with the gear member 71. Furthermore, the motor-side rotation shaft 72 is preferably provided with a clutch mechanism 75. This allows the rotation shaft 5 to be rotated without load, that is, to bear no load from the driving motor 73, while a first casing 11 and a second casing 12 are manually opened and closed relative to each other. It is contemplated that any suitable structure is possible for this clutch mechanism 75. The clutch mechanism 75 may, e.g., have a structure which allows the motor-side rotation shaft 72 to be rotatably driven via the driving motor 73, only when the latter is driven. With such a structure, the second casing 12 is manually opened and closed relative to the first casing 11 with no load from the driving motor 73.

Further, as shown in FIG. 4, a switch 17 is preferably mounted on a left side surface of a first casing 11. The switch 17 is used to activate the driving motor 73, which causes the rotation shaft 5 to be rotated. Due to the rotational movement of the rotation shaft 5, the compression spring 41 bends. The compression spring 41, with its biasing force, allows for an automatic slide biasing of the first casing 11 and the second casing 12 relative to each other either from a closed to an opened state or from an opened to a closed state. Moreover, the rotation shaft 5 may also include rotation control members (not shown) for controlling a rotation range of the rotation shaft 5. Preferably, the range of rotation is between 0° and 180°. In this case, the rotation control members may be mounted on a rotation shaft 5, in such a manner that an attaching end portion of the rotation shaft 5 connected with a compression coil spring 41 is turned, allowing for a rotation from one direction into the other direction.

Additionally, in the driving means 7, an actuator may be mounted in place of a driving motor 73 to effectuate a rotational movement of a rotation shaft 5. In this case, the rotation range of the rotation shaft 5 is preferably set in accordance with a stroke range of the actuator.

Next, an operation of the slide mechanism 1 and the portable telephone 10 will be explained.

When the portable telephone 10 is not in use, it is in its closed state, which is characterized in that the first casing 11 and the second casing 12 are superposed on each other, as shown, for example, in FIGS. 1A and 5A. In the closed state, the base member 2 and the slider 3 are slidably biased in a closing direction due to a biasing force of the compression spring 41, and thus the closed state of the first casing 11 and the second casing 12 is maintained. In one embodiment, a locking mechanism (not shown) may be provided for stably maintaining the first and second casings in the closed state.

To use the portable telephone 10 to make or receive calls, etc., the second casing 12 is, for example, manually displaced in the opening direction with the first casing 11 remaining stationary. The smaller the distance between both end portions of the compression spring 41, the more the compression spring 41 bends with a load thereon, against its own biasing force. Thereupon, as shown in FIG. 1B, at a minimum distance between both end portions of the compression spring 41, the compression spring 41is in a neutral state (see FIGS. 1B and 5B).

When the compression spring 41 bends further from the neutral state and both end portions thereof offset in opposite directions away from each other, both end portions thereof are biased to move apart from each other. As a result, the compression spring 41 regains its original shape. Also in this manner, the second casing 12 is slidably shifted automatically in an opening direction with regard to the first casing 11 and the second casing 12 reaches an opened state with regard to the first casing 11 and such a state is maintained between the two casings. See FIGS. 2B and 5C. Consequently, the keyboard portion 11a formed on the first casing 11 is exposed to allow the user to make telephone calls and perform keyboard operations. In one embodiment, a locking mechanism may be used to maintain the first and second casings in the opened state more reliably Accordingly, the first casing 11 and the second casing 12 semi-automatically slide with regard to each other when slidably shifted from the closed to the opened state.

For achieving an original position of the second casing 12 from an opened state, the second casing 12, e.g., slides in a closing direction with the first casing 11 remaining stationary. This in effect shortens the distance between both end portions of the compression spring 41, and from a neutral state (see FIG. 2A), the end portions are biased to move apart from each other. In this manner, the first casing 11 and the second casing 12 are slidably shifted automatically in a closing direction with regard to each other. The second casing 12 then reaches a closed state with regard to the first casing 11 and such a state of the two casings is maintained. See FIGS. 1A and 5A. Accordingly, the second casing 12 can semi-automatically slide with regard to the first casing 11 when slidably shifted from the closed to the opened state. Furthermore, the compression spring 41 is used as a slide biasing means 4 for manually sliding the second casing 12 with regard to the first casing 11, thus enabling a semi-automatic opening/closing with a simple structure.

Further, in using the portable telephone 10 for making telephone calls, the casings may be automatically opened and closed with a switch 17. In other words, if the switch 17 is operated while the portable telephone 10 in the closed state with, e.g., the first casing 11 remaining stationary, a drive motor 73 or an actuator is driven and the rotation shaft 5 is rotated via a motor-side rotation shaft 72, e.g., 180° counterclockwise, as shown in the drawings. With this rotation, a load is placed on the compression spring 41 of the semi-automatic mechanism 8, and the compression spring 41 bends against a biasing force of its own (see FIG. 2A). In this manner, the second casing 12 is slidably biased in an opening direction. In other words, the compression spring 41 bends in an automatic opening/closing operation in a direction contrary to that in a manual opening/closing operation. With such automatic opening operation, the second casing 12 slides from a closed to an opened state, and finally maintained in this opened state. As a result, the keyboard portion 11a formed on the upper surface of the first casing 11 is exposed, thus enabling telephone call and keyboard operation.

For achieving an original position of the second casing 12 from an opened state, the switch 17 is used while the first casing 11 remains stationary. A drive motor 73 or an actuator is driven and the rotation shaft 5 is rotated via a motor-side rotation shaft 72, e.g., 180° clockwise as in the drawings. With this rotation, a load is placed on the compression spring 41, and the compression spring 41 bends against a biasing force of its own (see FIG. 1B). In this manner, the second casing 12 is slidably biased in a closing direction. As a result, the second casing 12 slides in a closing direction. Thus, the second casing 12 automatically slides from an opened to a closed state. Accordingly, the first casing 11 and the second casing 12 automatically open and close with regard to each other with the use of switch 17.

Preferably, in the slide mechanism 1 and the portable telephone 10 according to the present invention, the compression spring 41 is used as the slide biasing means 4, thus allowing for an opening and closing with a simple structure. Further, according to the present invention, the fully automatic mechanism 9 is provided for slidably biasing the first casing 11 and the second casing 12 relative to each other automatically, with the use of the semi-automatic mechanism 8 and the slide biasing means 4 of the semi-automatic mechanism 8. With such fully automatic mechanism 9, the second casing 12 is opened and closed relative to the first casing 11 manually using the semi-automatic mechanism 8, as well as automatically using the fully automatic mechanism 9. Therefore, the portable telephone 10 is highly operable and easy-to-use, as the mode of operation can be selected according to a desired use of the portable telephone 10.

Moreover, the fully automatic mechanism 9 makes use of the compression spring 41 of the semi-automatic mechanism 8 for providing an automatic opening and closing operation of the first and second casings. This results in a remarkable reduction in the number of assembled parts in comparison to separately mounting an independent device solely for providing automatic opening and closing operation of the first and second casings. Thus, the resulting structure is simpler. Therefore, the slide mechanism 1 of the portable device and the portable telephone 10 according to the present invention enable both a manual and an automatic opening and closing with a simpler structure and reduced manufacturing costs.

As described above, the slide mechanism of the portable device according to the present invention is provided with a semi-automatic mechanism and a fully automatic mechanism, which slidably biases the first and second casings relative to each other using a slide biasing means of the semi-automatic mechanism. Such a slide mechanism realizes a manual opening and closing via a semi-automatic mechanism, as well as an automatic opening and closing via a fully automatic mechanism. These features provide the slide mechanism with excellent operability and capability of opening and closing the first and second casings with a simpler structure. Therefore, the slide mechanism is suitable for use in a wide range of portable devices, and especially portable telephones.

What is claimed is:

1. A slide mechanism of a portable device for relatively sliding a first casing and a second casing superposed on each other in a longitudinal direction between a closed state wherein an upper surface of one of said first casing and said second casing is covered with a lower surface of the other one of said first casing and said second casing, and an opened state wherein at least a portion of said upper surface of said one of said first casing and said second casing is exposed,
wherein a slide biasing means is swingably provided between said first casing and said second casing, said slide biasing means having one end portion being attached to said first casing and other end portion to said second casing, for slidably biasing said first casing and said second casing relative to each other from a predetermined opening/closing position in either of an opening and a closing direction.

2. A slide mechanism of a portable device for relatively sliding a first casing and a second casing superposed on each other in a longitudinal direction between a closed state wherein an upper surface of one of said first casing and said second casing is covered with a lower surface of the other one of said first casing and said second casing, and an opened state wherein at least a portion of said upper surface of said one of said first casing and said second casing is exposed, said slide mechanism comprising:
a slide biasing means swingably provided between said first casing and said second casing, said slide biasing means having two end portions;
a semi-automatic mechanism provided between said first casing and said second casing and having one end portion of said slide biasing means attached to a first attaching portion of said first casing and other end portion of said slide biasing means to a second attaching portion of said second casing; and
a fully automatic mechanism having either one of said first attaching portion and said second attaching portion rotatably attached to either one of said first casing and said second casing, and a driving means adapted to rotate said one of said first attaching portion and second attaching portion so as to slidably bias said first casing and said second casing relative to each other via a biasing force of said slide biasing means automatically, either from said closed state to said opened state or from said opened state to said closed state, wherein a manual opening and closing operation via said semi-automatic mechanism and an automatic opening and closing operation via said fully automatic mechanism both utilize said slide biasing means of said semi-automatic mechanism.

3. The slide mechanism of the portable device according to claim 2, wherein said slide biasing means is a compression spring.

4. The slide mechanism of the portable device according to claim 2,
wherein said first casing and said second casing are slidably engaged with each other via a base member mounted on one of said first casing and said second casing, and a slider slidably engaged with the base member and mounted on the other one of said first casing and said second casing.

5. The slide mechanism of the portable device according to claim 2, wherein said driving means comprises a gear member attached to one of said first attaching portion and said second attaching portion; and
a driving motor having a motor-side rotation shaft adapted to rotatably mesh with the gear member and rotate the motor-side rotation shaft in clockwise and counter clockwise directions.

6. The slide mechanism of the portable device according to claim 5, wherein said driving motor is a motor which enables said motor-side rotation shaft to be rotated with no load during said manual opening and closing operation of said first casing and said second casing.

7. A portable telephone comprising the slide mechanism of the portable device according to claim 1.

8. A portable telephone comprising the slide mechanism of the portable device according to claim 2.
